(19) United States
(12) Patent Application Publication
(10) Pub. No.: US 2008/0315681 A1
(43) Pub. Date: Dec. 25, 2008

(54) Energy Recovery in Hybrid Vehicles Having a Conventional Hydraulic or Pneumatic Brake System

(76) Inventors: Steffen Waldenmeier, Kieselbronn (DE); Peter Ahner, Boeblingen (DE); Klaus Beulich, Weil Der Stadt (DE)

Correspondence Address: KENYON & KENYON LLP, ONE BROADWAY, NEW YORK, NY, 10004, US

(21) Appl. No.: 12/090,576

(22) PCT Filed: Sep. 19, 2006
(86) PCT No.: PCT/EP06/66480

§ 371 Date: Jul. 2, 2008

(30) Foreign Application Priority Data
Nov. 16, 2005 (DE) 10 2005 054 617.5

(51) Int. Cl. B60W 30/18; G06F 19/00

(52) U.S. Cl. 303/152; 701/99

(57) ABSTRACT

A device and a method for recovering energy during a braking operation of a hybrid vehicle which includes an electric machine in addition to an internal combustion engine, as well as a hydraulic or pneumatic brake system which is operated by a foot brake pedal). The recovery device includes a pedal position transducer which detects at least an actuation of the foot brake pedal in an initial range, and an electronic system which evaluates the signal of the pedal position transducer and activates the electric machine accordingly in generator mode when the driver actuates the foot brake pedal in the initial range.

### FIELD OF THE INVENTION

The present invention relates to a method and device for recovering energy during a braking operation of a hybrid vehicle.

### BACKGROUND INFORMATION

In addition to an internal combustion engine, hybrid vehicles usually have an electric machine which is operated in either motor or generator mode, depending on the driving situation. In motor mode, the electric machine generates an additional driving torque, which supports the internal combustion engine, for example during an acceleration phase. In generator mode, on the other hand, the kinetic energy released during vehicle deceleration is converted into electrical energy (recovery). The electrical energy thus obtained is stored in an energy accumulator unit, such as a battery or supercapacitor, and may be used in other driving situations, for example to propel the vehicle or supply electrical consumers. The vehicle efficiency may be substantially increased thereby.

The quantity of electrical energy which may be generated by the generator is a function of the charge state or capacity of the energy accumulator unit. If the energy accumulator unit is fully charged, only a small amount of electrical energy, or none at all, may be fed into the vehicle electrical system, since this might otherwise overload the energy accumulator unit or damage voltage-sensitive consumers. The power supplied by the generator is set accordingly by a controller.

In recovery mode, the generator generates a power-dependent braking or drag torque. In principle, the drag torque increases as more electrical power is generated. Due to the dependency on the charge state of the electrical energy accumulator unit, the drag torque may vary greatly. During a braking operation initiated by the driver (by actuating the service brake), in which the electric machine is connected in recovery mode, the braking operation of the vehicle also varies accordingly. This impairs driving safety.

Hybrid vehicles having a conventional hydraulic or pneumatic brake system (in which the brake pedal is mechanically engaged with the individual wheel brakes) are therefore designed in such a way that energy is recovered only while the vehicle is coasting to a stop (not during braking) or if only a very small amount of energy is recovered during braking, thereby minimizing the influence of the generator. However, this has the great disadvantage that the maximum amount of electrical power generatable by the generator—provided the energy accumulator unit has sufficient capacity—is not fully utilized, and therefore vehicle efficiency may be only slightly improved.

Maximum recovery of braking energy is usually possible only in the case of hybrid vehicles having an electrohydraulic brake system (EHB), since the fluctuating braking action of the generator in such systems may be compensated (usually by varying the braking characteristic). In this case, the driver always feels the same braking action when pressing the brake pedal with the same amount of force. This compensation is possible only in the case of electrohydraulic brake systems, but not when using purely hydraulic or purely pneumatic brake systems.

### SUMMARY

An object of the present invention is to provide a method and a device for recovering energy in hybrid vehicles, which enable a maximum amount of energy to be recovered without excessively impairing the braking action of the service brake.

One aspect of the present invention is obtaining electrical energy primarily in an initial range of the brake pedal travel and preferably to reduce the generator power when the foot brake pedal is actuated beyond the initial range or to completely deactivate the generator mode. The initial range is preferably a range in which the service brake does not yet respond, or in which only a slight braking action develops, and it is preferably less than 20 mm of pedal travel. By limiting the recovery to this initial range, the generator does not impair, or only slightly impairs, the braking performance of the vehicle when the brake is pressed with greater force. If the driver only lightly taps the brake pedal, on the other hand, a maximum amount of electrical power is recoverable. In this case, the braking action of the generator is also dependent on the charge stage of the electrical energy accumulator unit, but the driver does not issue a specific braking request which must be carried out precisely. An advantage of this system is therefore that, in non-critical driving situations, for example when the vehicle is coasting to a stop at a traffic light, the driver may recover a maximum amount of energy at his own initiative by lightly tapping the brake pedal.

The initial range of pedal actuation, in which the recovery is mainly active, is preferably defined by the brake clearance and preferably extends to a working point at which the service brake begins to respond. In most conventional brake systems, this working point is located at approximately 6 mm to 10 mm of pedal travel. However, the initial range may also be set, independently of the working point, to any other value, which is preferably less than 20 mm and, in particular, approximately 10 mm.

The amount of energy recovered preferably depends on how hard the driver taps the brake pedal, provided that the energy accumulator unit has sufficient capacity. In other words, the generator power is preferably a function of brake pedal travel or pedal force. According to a preferred embodiment of the present invention, the recovery system is designed in such a way that, when the foot brake is actuated in the initial range, the generator generates a higher generator power as the pedal travel increases. This enables the driver to recover more or less energy, as desired. The amount of recovered energy may be displayed to the driver, for example on a screen.

To resolve the initial range, a pedal position transducer is provided, whose signal is evaluated by an electronic system, in particular a control unit. The electronic system controls the generator or a pulse rectifier in such a way that, to the extent possible, electrical energy is fed into the vehicle electrical system when the driver actuates the foot brake pedal in the initial range.

The pedal position transducer may be, for example, a stationary sensor (such as a distance sensor) and a transducer situated on the brake pedal, such as a reference plate. The pedal position transducer may be implemented, for example, as an inductive or capacitive distance sensor. A magnetic field sensor, such as a Hall, AMR or GMR sensor, is preferably used. Other conventional sensor types may also be used. The pedal position transducer may also be situated either on a push rod between the brake pedal and brake cylinder or in the brake booster. The important thing is that at least the initial range of the pedal actuation be resolvable.

### BRIEF DESCRIPTION OF THE DRAWINGS

The present invention is explained in greater detail.

FIG. 1 shows a schematic representation of a recovery system according to a specific embodiment of the present invention.

FIG. 2 shows a diagram for illustrating the generator power as a function of the pedal travel.

FIG. 3 shows a schematic view of a brake pedal having a pedal position transducer.

### DETAILED DESCRIPTION OF EXAMPLE EMBODIMENTS

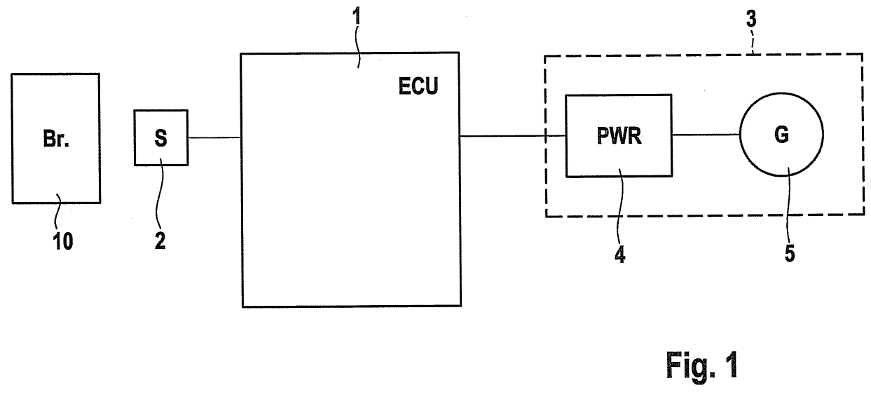

FIG. 1 shows a block diagram of a recovery system for recovering electrical energy during a braking operation of a hybrid vehicle, which includes an electric machine 3 in addition to the internal combustion engine. Electric machine 3 is operated as a generator in recovery mode and in this mode generates electrical energy which is stored in an energy accumulator unit (not illustrated) of the vehicle electrical system.

The recovery system includes a pedal position transducer 2 which is assigned to foot brake pedal 10 and is connected to a control unit 1, which evaluates the sensor signal and activates electric machine 3 accordingly. Electric machine 3 includes actual machine 5 as well as a pulse inverter 4, which may be used to set the operating mode (generator mode or motor mode) and the power of machine 5.

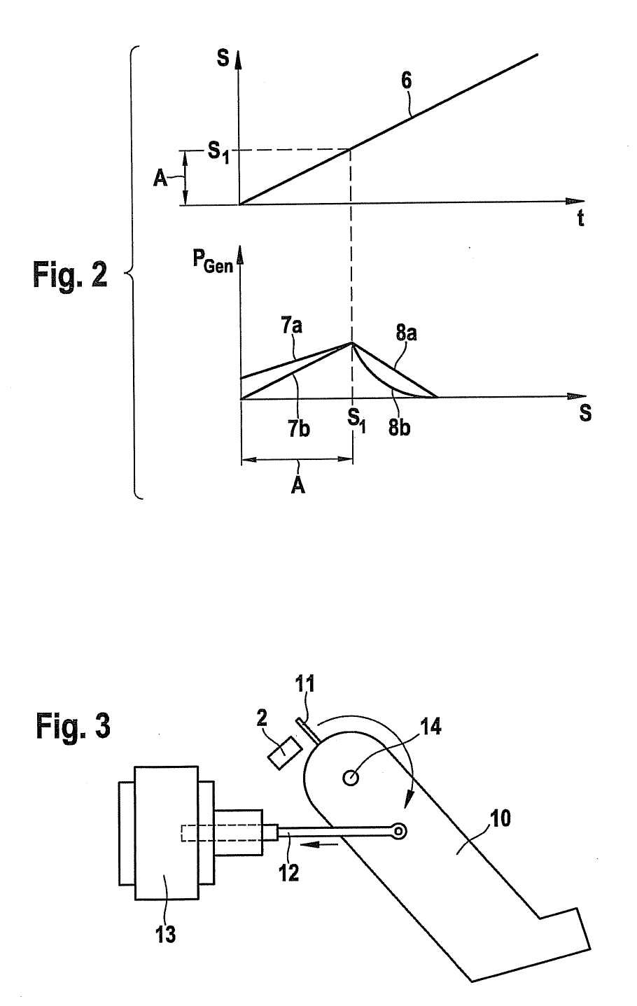

The recovery system in this case is designed in such a way that generator 5 generates electrical energy primarily in an initial range A (see FIG. 2 below) of pedal travel s. If brake pedal 10 is operated beyond this range, however, the electrical power is reduced or the generator mode is deactivated completely. Initial range A may extend, for example, only for a few millimeters, for example 6 to 10 mm. Initial range A is preferably defined by the brake clearance and extends to a working point s1 at which the service brake begins to respond.

In the upper diagram, FIG. 2 shows the curve of an exemplary braking operation in which foot brake pedal 10 is pressed with increasing force, starting from the zero position, and pedal travel s thus increases in a ramp-like manner. The lower diagram shows corresponding generator power P_{gen} as a function of pedal travel s. In the case of curve 7b, generator power P_{gen} increases steadily in initial range A, starting at zero-provided that the energy accumulator unit has sufficient capacity. If pedal 10 is pressed beyond limit value s1, the generator power is reduced. The reduction may take place in a linear (characteristic 8a), exponential (characteristic 8b) or any other fashion. Alternatively, the generator mode may also be deactivated completely (abrupt reduction). By doing this, the driver is able to lightly tap brake pedal 10 and thereby actively recover electrical energy. However, the vehicle braking performance is not or only slightly impaired by pressing the brake pedal with greater force.

In the case of characteristic 7a, electrical energy is recovered even when the vehicle is coasting to a stop (without foot brake pedal 10 being actuated). The driver may further increase the electrical power by lightly tapping the brake pedal.

FIG. 3 shows a schematic side view of a foot brake pedal 10 after being moved a few millimeters away from the zero position. The diagram shows brake pedal 10, which acts upon brake booster 13 via a push rod 12. When actuated, pedal 10 swivels around axis 14. The system also includes a pedal position transducer 2, 11, which has a distance sensor 2 and a reference plate 11 situated at the upper end of pedal 10. Pedal position transducer 2, 11 measures the distance of reference plate 11 from sensor 2, which is mounted in a stationary manner, and is designed so that at least initial range A of a pedal actuation is resolvable.

1-9. (canceled)

10. A method for recovering energy in a hybrid vehicle which includes an electric machine, an internal combustion engine, and a hydraulic or pneumatic brake system which is operated by a foot brake pedal, the method comprising:
detecting via a sensor at least an initial range of a pedal actuation; and
operating the electric machine in generator mode when a driver actuates the foot brake pedal in the initial range.

11. The method as recited in claim 10, wherein a magnitude of generator power is a function of a travel of the brake pedal or a pedal force.

12. The method as recited in claim 11, wherein the electric machine is operated in the initial range so that the electric machine generates a higher generator power as the travel of the brake pedal increases.

13. The method as recited in claim 10, wherein generator power is reduced or the generator mode is deactivated completely when the foot brake pedal is actuated beyond the initial range.

14. The method as recited in claim 10, wherein the initial range corresponds to a pedal travel of less than 10 mm.

15. The method as recited in claim 14, wherein the initial range corresponds to a pedal travel of between 6 mm and 8 mm.

16. A device for recovering energy in a hybrid vehicle which includes an electric machine, an internal combustion engine, and a hydraulic or pneumatic brake system which is actuated by a foot brake pedal, the device comprising:
a pedal position transducer adapted to detect an actuation of the foot brake pedal in at least an initial range; and
an electronic system adapted to evaluate a signal of the pedal position transducer and to activate the electric machine in generator mode when a driver actuates the foot brake pedal in the initial range.

17. The device as recited in claim 16, wherein an amount of generator power is a function of a travel of the brake pedal or a pedal force.

18. The device as recited in claim 16, wherein the electric machine is operated in the initial range in such a way that the electric machine generates a higher generator power as the travel of the brake pedal increases.

19. The device as recited in claim 16, wherein the pedal position transducer includes a distance sensor and a reference plate mounted on the pedal.
